(19) United States
(12) Patent Application Publication
(10) Pub. No.: US 2024/0337380 A1
(43) Pub. Date: Oct. 10, 2024

(54) HYDROGEN FLAME IONIZATION DETECTOR AND GAS CHROMATOGRAPH

(71) Applicant: SHIMADZU CORPORATION, Kyoto-shi (JP)

(72) Inventor: Ryosuke YAMAMOTO, Kyoto-shi (JP)

(21) Appl. No.: 18/623,814

(22) Filed: Apr. 1, 2024

(30) Foreign Application Priority Data
Apr. 7, 2023 (JP) 2023-062527

(51) Int. Cl. F23D 14/58; G01N 30/68

(52) U.S. Cl. CPC F23D 14/58; G01N 30/68

(57) ABSTRACT

A hydrogen flame ionization detector includes a base having an opening and a passage, a nozzle having a tubular section and an ejection section, and a collector. The tubular section is housed within the passage of the base with a gap between an outer peripheral surface of the tubular section and an inner peripheral surface of the passage. The outer peripheral surface of the ejection section is in direct surface contact with the base at an upper end portion of the passage. The surface contact forms a sealing portion that prevents a gas from leaking upward along an outer side of the ejection section, and the base is configured to function as a heat sink for absorbing heat of the nozzle.

### CROSS-REFERENCE TO RELATED APPLICATIONS

This application claims priority under 35 U.S.C. § 119 to Japanese Patent Application No. 2023-062527 filed on Apr. 7, 2023, the entire disclosure of which is incorporated herein by reference in its entirety.

### BACKGROUND OF THE INVENTION

### Field of the Invention

The following description sets forth the inventor's knowledge of the related art and problems therein and should not be construed as an admission of knowledge in the prior art.

An FID is often used as a detector for a gas chromatograph. In an FID, a hydrogen flame is formed at the tip of a nozzle located at the exit of the separation column, and ions originating from the sample components, which are generated by the hydrogen flame, are collected by a collector to quantify the concentration of each component in the sample (see Patent Document 1).

### PRIOR ART DOCUMENT

### Patent Document

Patent Document 1: Japanese Unexamined Patent Application Publication No. 2000-206091

When analyzing a high-concentration sample using an FID as a detector, the reproducibility of the analysis results may deteriorate. The present inventor has gained the insight that one of the causes of these problems is that the inner diameter of the nozzle inside the FID expands under the influence of the rising temperature of the hydrogen flame, causing the flow rate of the gas ejected from the tip of the nozzle to fluctuate. If the flow rate of the gas ejected from the tip of the nozzle fluctuates, the detection sensitivity varies depending on the concentration of the component in the sample, reducing the reproducibility of the analysis.

### SUMMARY OF THE INVENTION

The present disclosure has been made to solve the above-described problems. The purpose of the present disclosure is to suppress changes in the inner diameter of a nozzle inside an FID due to the influence of a hydrogen flame.

A hydrogen flame ionization detector (FID) according to the present disclosure includes:
a base provided with an opening at its upper end and a passage through which a sample gas is introduced from below;
a nozzle having a tubular section and an ejection section, the tubular section being housed within the passage of the base with a gap between an outer peripheral surface of the tubular section and an inner peripheral surface of the passage, the ejection section being provided at an upper end of the tubular section and provided with an ejection port at a tip of the ejection section, the ejection section being configured to eject a gas upward, an outer peripheral surface of the ejection section being in direct surface contact with the base at an upper end portion of the passage; and
a collector provided above the ejection section of the nozzle, the collector being configured to collect ions generated by a hydrogen flame formed above the ejection port of the nozzle,
wherein a combustion supporting gas is introduced into the gap between the inner peripheral surface of the passage in the base and the outer peripheral surface of the tubular section of the nozzle,
wherein the surface contact between the ejection section of the nozzle and the base forms a sealing portion that prevents a gas in the gap between the outer peripheral surface of the tubular section of the nozzle and the inner peripheral surface of the passage of the base from leaking upward along an outer side of the ejection section, and
wherein the base is configured to function as a heat sink for absorbing heat of the nozzle.

In the FID of the present disclosure, a nozzle having a tubular section and an ejection section positioned at the upper end of the tubular section is attached to the upper end of the passage of the base. A combustion supporting gas (hydrogen gas) and a make-up gas are introduced into the gap between the inner peripheral surface of the passage of the base and the outer peripheral surface of the tubular section of the nozzle. A sample gas is introduced from below the tubular section of the nozzle. The combustion supporting gas and the make-up gas reach the lower end of the tubular section through the gap between the inner peripheral surface of the passage of the base and the outer peripheral surface of the tubular section of the nozzle, mix with the sample gas in the nozzle, and are ejected upward from the ejection port at the tip of the ejection section to form a hydrogen flame.

In the FID with this structure, it is necessary to prevent a part of the combustion supporting gas and the make-up gas from ascending through the gap between the inner peripheral surface of the passage of the base and the nozzle without being mixed with the sample gas and leaking upwards. If a part of the combustion supporting gas and the make-up gas leaks upward without being mixed with the sample gas, the amount of gas ejected from the nozzle ejection port changes, resulting in a change in the sensitivity of the FID. Therefore, the ejection section of the nozzle and the edge of the passage in the base are brought into line contact with each other and firmly pressed together. With this, a high sealing performance was generally secured to ensure that the gas between the inner peripheral surface of the passage in the base and the outer peripheral surface of the nozzle does not leak upward.

On the other hand, in the structure in which the base and the nozzle are in linear contact, the heat from the nozzle is not easily transferred to the base, and therefore, the nozzle tends to become high in temperature due to the heat from the hydrogen flame. Therefore, in the present disclosure, the base and the nozzle are brought into surface contact with each other to increase the contact area, enabling the base to function as a heat sink that absorbs the heat from the nozzle. When the base and the nozzle are brought into surface contact, there is a possibility that the sealing performance deteriorates as compared with the case in which they are brought into linear contact.

However, the present inventor has experimentally confirmed that the pressure between the inner peripheral surface of the passage in the base and the outer peripheral surface of the nozzle generally does not exceed 10 kPa, and even when the base and the nozzle are in surface contact with each other, this is sufficient to ensure the sealing performance to prevent the gas in the gap between the inner peripheral surface of the passage in the base and the outer peripheral surface of the nozzle from leaking upwards.

In other words, the present disclosure is based on the findings that, in the sealing portion for preventing the upward leakage of the gas in the gap between the inner peripheral surface of the passage in the base and the outer peripheral surface of the nozzle, even in the case where the base and the nozzle are brought into surface contact with each other, it is possible to secure sufficient sealing performance that can fulfill the function as a sealing portion, and at the same time, it is also possible to enhance the heat transfer efficiency from the nozzle to the base to enable the base to act as a heat sink for the nozzle.

Note that in the structure disclosed in Patent Document (Japanese Unexamined Patent Application Publication No. 2000-206091), which is disclosed as a conventional technology, the combustion supporting gas and the make-up gas are not introduced between the inner peripheral surface of the passages in the base and the outer peripheral surface of the tubular section of the nozzle. Further note that, in FIG. 2 of this Patent Document, the outer peripheral surface of the lower end of the nozzle is depicted as of it is in surface contact with the base, but in reality, the nozzle's lower end is merely inserted into the passage in the base, and the nozzle and the base are not in thermal contact with each other at this portion.

In the FID of the present disclosure, the surface contact between the ejection section of the nozzle and the base forms a sealing portion that prevents the gas in the gap between the outer peripheral surface of the tubular section of the nozzle and the inner peripheral surface of the passage in the base from leaking upward along the outside of the ejection section. Further, the base is configured to function as a heat sink for absorbing the heat from the nozzle. Therefore, it is possible to suppress changes in the inner diameter of the nozzle due to the effect of the heat from the hydrogen flame.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspects or features of other embodiments where applicable. The descriptions of aspects, features and/or advantages of particular embodiments should not be construed as limiting other embodiments or the claims.

### BRIEF DESCRIPTION OF THE DRAWINGS

Some preferred embodiments of the present disclosure are shown by way of example, and not limitation, in the accompanying figures.

FIG. 1 is a cross-sectional view showing one example of a hydrogen flame ionization detector according to a first embodiment.

FIG. 2 is a cross-sectional view of a modification of the structure of the upper end portion of the passage in the base.

### DETAILED DESCRIPTION OF THE PREFERRED EMBODIMENTS

In the following paragraphs, some preferred embodiments of the present disclosure will be described by way of example and not limitation. It should be understood based on this disclosure that various other modifications can be made by those skilled in the art based on these illustrated embodiments.

Hereinafter, with reference to the drawings, an embodiment of a hydrogen flame ionization detector (hereinafter referred to as “FID”) according to the present disclosure will be described.

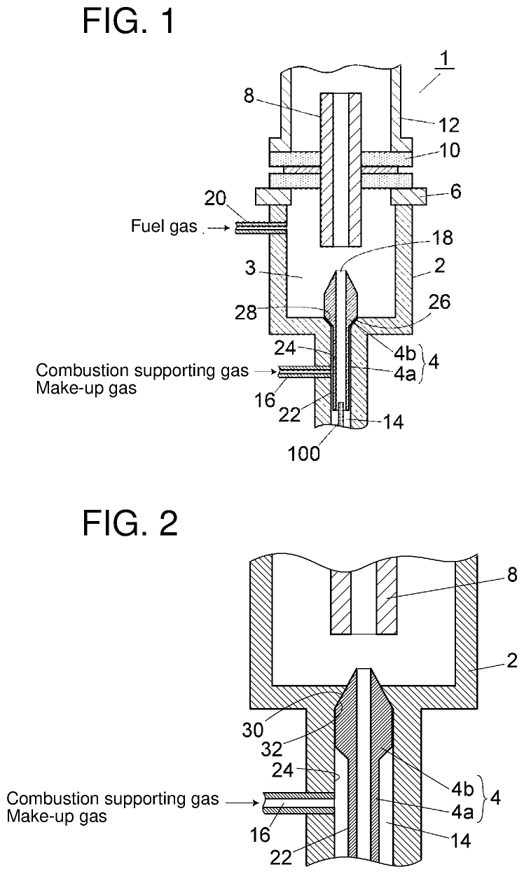

FIG. 1 shows the internal cross-sectional structure of an example of an FID.

The FID 1 is equipped with a base 2, a nozzle 4, a collector holding member 6, a collector 8, an insulator 10, and a housing 12.

The base 2 is a hollow cylindrical metal member having an opening at its upper surface and a space 3 inside. At the lower portion of the base 2, a vertically extending passage 14, which leads to the space 3, is provided. The downstream end of a separation column 100 of a gas chromatograph is inserted into the passage 14 from the lower end.

The nozzle 4 has a tubular section 4a and an ejection section 4b provided at the tip of the tubular section 4a. The tubular section 4a of the nozzle 4 has an outer diameter smaller than the inner diameter of the passage 14 in the base 2. The base portion of the ejection section 4b, which is joined to the tubular section 4a, gradually expands in the outer diameter toward the tip (upper side in the figure), and the maximum outer diameter of the ejection section 4b is larger than the inner diameter of the passage 14a. The tubular section 4a of the nozzle 4 is housed in the passage 14, and the tip side portion of the ejection section 4b protrudes upward from the passage 14. The downstream end of a separation column 100 is inserted into the lower end of the tubular section 4a. An ejection port 18 is provided at the tip of the ejection section 4b, and the sample gas flowing out of the separation column 100 flows through the nozzle 4 and is ejected upward from the ejection port 18.

A first piping 16 that supplies a combustion supporting gas (hydrogen gas) and a make-up gas is attached to the base 2. The first piping 16 leads to the passage 14, and the combustion supporting gas and the make-up gas supplied through the first piping 16 are introduced into the gap between the outer peripheral surface 22 of the tubular section 4a of the nozzle 4 and the inner peripheral surface 24 of the passage 14. The combustion supporting gas and the make-up gas flow downward through the gap between the outer peripheral surface 22 of the tubular section 4a and the inner peripheral surface 24 of the passage 14, enter the inside of the nozzle 4 from the lower end of the tubular section 4a, and are ejected from the ejection port 18 into the space 3 together with the sample gas flowing out of the separation column 100 to form a hydrogen flame.

A collector holding member 6 is mounted on the upper part of the base 2, and a housing 12 is mounted on the collector holding member 6 with two insulators 10 interposed between them. Although not shown in the figures, an igniter is provided in the space 3 of the base 2 to form a hydrogen flame at the tip of the nozzle 4. Each of the two insulators 10 is a disk-shaped insulating member for holding the outer peripheral surface of the collector 8.

The collector 8 is a hollow cylindrical member with openings at both ends, and the insulator 10 is attached to the outer peripheral surface of the collector 8 so as to spread from the outer periphery of the collector 8 in the circumferential direction. The peripheral portion of the insulator 10 is sandwiched between the collector holding member 6 and the housing 12, ensuring that the collector 8 is positioned above the nozzle 4 with its axial direction oriented vertically. The collector 8 is an electrode for collecting ions produced by the hydrogen flame formed at the tip of the nozzle 4. A second piping 20 is attached to the base 2 to supply a fuel gas to the space 3.

The section of the outer peripheral surface of the ejection section 4b of the nozzle 4 that is closest to the tubular section 4a forms a tapered portion 26 with a tapered shape. The upper end portion of the passage 14 in the base 2 is provided with a tapered portion 28 facing the tapered portion 26 of the outer peripheral surface of the nozzle 4, having the same taper angle as that of the tapered portion 26. The tapered portion 26 of the nozzle 4 and the tapered portion 28 of the base 2 are in surface contact with each other.

Although not shown in the figures, a threaded portion is provided on a part of the outer peripheral surface 22 of the tubular section 4a of the nozzle 4, and a corresponding threaded portion is provided at a position on the inner peripheral surface 24 of the passage 14 so as to be engaged with the threaded portion on the outer peripheral surface of the tubular section 4a. The nozzle 4 is secured to the base 2 by inserting the lower end of the tubular section 4a of the nozzle 4 into the passage 14 from above and rotating the nozzle 4 to engage the threaded portion of the outer peripheral surface of the nozzle 4 with the threaded portion in the passage 14. When the nozzle 4 is tightened against the base 2 by being rotated, the tapered portion 26 of the nozzle 4 and the tapered portion 28 of the base 2 come into surface contact with each other and are pressed against each other, securing them in place.

The surface contact between the tapered portion 26 of the nozzle 4 and the tapered portion 28 of the base 2 creates a sealing portion that prevents the combustion supporting gas and the make-up gas, which are introduced into the gap between the outer peripheral surface 22 of the tubular section 4a and the inner peripheral surface 24 of the passage 14, from leaking into the space 3 along the outside of the ejection section 4b, without flowing into the interior of the nozzle 4. Furthermore, the base 2 and the nozzle 4 are in surface contact with each other at this sealing portion, which ensures good heat transfer from the nozzle 4 to the base 2, and therefore, the base 2 functions as a heat sink for absorbing the heat from the nozzle 4.

The tapered portion 28, provided at the upper end portion of the passage 14 in the base 2, serves as a guide when mounting the nozzle 4 onto the base 2, thereby enhancing the axial alignment accuracy of the nozzle 4 with the collector 8. This reduces individual differences and assembly errors for each FID 1 with respect to the positional relation between the nozzle 4 and the collector 8, and suppresses the variation in detection sensitivity for each FID 1.

The structure for forming the sealing portion by bringing the base 2 and the nozzle 4 into surface contact with each other is not limited to that described above. FIG. 2 shows a modification of the structure of the upper end portion of the passage 14.

In the example in FIG. 2, the outer peripheral surface of the tip portion of the ejection section 4b of the nozzle 4 forms a tapered portion 30, which is tapered so that its outer diameter increases from the tip side (upper side in the figure) to the base end side (lower side in the figure). The inner peripheral surface of the upper end portion of the passage 14 in the base 2 is formed into a tapered portion 32 that faces the tapered portion 30 of the ejection section 4b, the tapered portion 32 having the same taper angle as that of the tapered portion 30.

A threaded portion is provided on a part of the outer peripheral surface of either the tubular section 4a or the ejection section 4b of the nozzle 4, and a thread portion, which engages with the thread portion on the outer peripheral surface of the nozzle 4, is provided at a corresponding position on the inner peripheral surface of the passage 14. Fixing the nozzle 4 to the base 2 is performed by inserting the nozzle 4 from below into the passage 14 and then rotating it.

When the nozzle 4 is rotated and tightened upward against the base 2 by being rotated, the tapered portion 30 of the nozzle 4 and the tapered portion 32 of the base 2 come into surface contact and are press against each other.

The surface contact between the tapered portion 30 of the nozzle 4 and the tapered portion 32 of the base 2 creates a sealing portion that prevents the combustion supporting gas and the make-up gas, which are introduced into the gap between the outer peripheral surface 22 of the tubular section 4a and the inner peripheral surface 24 of the passage 14, from leaking into the space 3 along the outside of the ejection section 4b, without flowing into the interior of the nozzle 4. Furthermore, the base 2 and the nozzle 4 are in surface contact with each other at this sealing portion, which ensures good heat transfer from the nozzle 4 to the base 2. Therefore, the base 2 functions as a heat sink for absorbing the heat from the nozzle 4.

Further, with the structure shown in FIG. 2, the slope of the tapered portion 32 on the inner side of the passage 14 functions as a guide when mounting the nozzle 4 onto the base 2, improving the axial alignment accuracy of the nozzle 4 with the collector 8 when mounting the nozzle 4. This reduces individual differences and assembly errors for each FID 1 with respect to the positional relation between the nozzle 4 and the collector 8, and suppresses the variation in detection sensitivity for each FID 1.

### ASPECTS

It should be understood that the example described above is only one example of the embodiment of the hydrogen flame ionization detector according to the present disclosure. Embodiments of the hydrogen flame ionization detector of the present disclosure are as follows

### Item 1

A hydrogen flame ionization detector according to one embodiment according to the present disclosure comprising:
a base provided with an opening at its upper end and a passage through which a sample gas is introduced from below;
a nozzle having a tubular section and an ejection section, the tubular section being housed within the passage of the base with a gap between an outer peripheral surface of the tubular section and an inner peripheral surface of the passage, the ejection section being provided at an upper end of the tubular section and provided with an ejection port at a tip of the ejection section, the ejection section being configured to eject a gas upward, an outer peripheral surface of the ejection section being in direct surface contact with the base at an upper end portion of the passage; and
a collector provided above the ejection section of the nozzle, the collector being configured to collect ions generated by a hydrogen flame formed above the ejection port of the nozzle,
wherein a combustion supporting gas is introduced into the gap between the inner peripheral surface of the passage in the base and the outer peripheral surface of the tubular section of the nozzle,
wherein the surface contact between the ejection section of the nozzle and the base forms a sealing portion that prevents a gas in the gap between the outer peripheral surface of the tubular section of the nozzle and the inner peripheral surface of the passage of the base from leaking upward along an outer side of the ejection section, and
wherein the base is configured to function as a heat sink for absorbing heat of the nozzle.

### Item 2

In the hydrogen flame ionization detector as recited in the above-described Item [1], it may be configured such that:
a part of the outer peripheral surface of the ejection section of the nozzle is formed as a tapered portion having a tapered shape,
a part of the inner peripheral surface of the passage of the base is formed in a tapered portion, the tapered portion facing the tapered portion of the ejection section and having the same taper angle as that of the tapered portion of the ejection section, and
the tapered portion of the ejection section and the tapered portion of the base are in surface contact with each other.

According to the hydrogen flame ionization detector as recited in the above-described Item [2], the nozzle and the base have tapered portions with the same taper angle, and their tapered portions are in surface contact with each other. Therefore, when mounting the nozzle to the base, the slope of the tapered portion of the base can function as a guide to lead the nozzle to the correct mounting position, thereby improving the axial alignment accuracy of the nozzle with respect to the collector.

### Item 3

In the hydrogen flame ionization detector as recited in the above-described Item [1], it may be configured such that
the outer peripheral surface of the nozzle is provided with a threaded portion, and the inner peripheral surface of the passage is provided with a threaded portion to be threaded with the threaded portion of the nozzle, and
the tapered portion of the nozzle and the tapered portion of the base are configured to be pressed against each other by threading the threaded portion of the outer peripheral surface of the nozzle with the threaded portion of the inner peripheral surface of the passage and tightening the nozzle to the base.

According to the hydrogen flame ionization detector as recited in the above-described Item [3], the adhesion between the tapered portions of the nozzle and the base is improved. Therefore, heat transfer from the nozzle to the base is facilitated, which enhances the effectiveness in preventing the nozzle from overheating.

While illustrative embodiments of the present disclosure have been described herein, the present disclosure is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

### DESCRIPTION OF REFERENCE SYMBOLS

1: Hydrogen flame ionization detector
2: Base
4: Nozzle
6: Collector holding member
8: Collector
10: Insulator
12: Housing
14: Passage
16, 20: Piping
18: Ejection port
26, 34: Nozzle tapered portion
28, 36: Nozzle tapered portion

1. A hydrogen flame ionization detector comprising:
a base provided with an opening at its upper end and a passage through which a sample gas is introduced from below;
a nozzle having a tubular section and an ejection section, the tubular section being housed within the passage of the base with a gap between an outer peripheral surface of the tubular section and an inner peripheral surface of the passage, the ejection section being provided at an upper end of the tubular section and provided with an ejection port at a tip of the ejection section, the ejection section being configured to eject a gas upward, an outer peripheral surface of the ejection section being in direct surface contact with the base at an upper end portion of the passage; and
a collector provided above the ejection section of the nozzle, the collector being configured to collect ions generated by a hydrogen flame formed above the ejection port of the nozzle,
wherein a combustion supporting gas is introduced into the gap between the inner peripheral surface of the passage in the base and the outer peripheral surface of the tubular section of the nozzle,
wherein the surface contact between the ejection section of the nozzle and the base forms a sealing portion that prevents a gas in the gap between the outer peripheral surface of the tubular section of the nozzle and the inner peripheral surface of the passage of the base from leaking upward along an outer side of the ejection section, and
wherein the base is configured to function as a heat sink for absorbing heat of the nozzle.

2. The hydrogen flame ionization detector as recited in claim 1,
wherein a part of the outer peripheral surface of the ejection section of the nozzle is formed as a tapered portion having a tapered shape,
wherein a part of the inner peripheral surface of the passage of the base is formed in a tapered portion, the tapered portion facing the tapered portion of the ejection section and having the same taper angle as that of the tapered portion of the ejection section, and
wherein the tapered portion of the ejection section and the tapered portion of the base are in surface contact with each other.

3. The hydrogen flame ionization detector as recited in claim 2,
wherein the outer peripheral surface of the nozzle is provided with a threaded portion, and the inner peripheral surface of the passage is provided with a threaded portion to be threaded with the threaded portion of the nozzle, and
wherein the tapered portion of the nozzle and the tapered portion of the base are configured to be pressed against each other by threading the threaded portion of the outer peripheral surface of the nozzle with the threaded portion of the inner peripheral surface of the passage and tightening the nozzle to the base.
